(19) United States
(12) Patent Application Publication
(10) Pub. No.: US 2011/0275477 A1
(43) Pub. Date: Nov. 10, 2011

(54) Planetary gear speed reducer

(75) Inventors: Long-Chang Hsieh, Yunlin (TW); An-Chen Lee, Hsinchu (TW); Tzu-Hsia Chen, Yunlin (TW); Hsiu-Chen Tang, Yunlin (TW)

(73) Assignee: NATIONAL FORMOSA UNIVERSITY, Yunlin (TW)

(21) Appl. No.: 12/805,251

(22) Filed: Jul. 21, 2010

(30) Foreign Application Priority Data
May 10, 2010 (TW) 99114735

(51) Int. Cl. F16H 57/08

(52) U.S. Cl. 475/331

(57) ABSTRACT

A planetary gear speed reducer includes a gear bracket having a center hole and first, second and third locating portions arranged in parallel along the center hole, a sun gear mounted in the center hole of the gear bracket, first gears rotatably mounted in between the first and second locating portions of the gear bracket and meshed with the sun gear, second gears rotatably mounted in between the second and third locating portions of the gear bracket and meshed with the sun gear, and two annular gears respectively meshed with the first gears and the second gears. Enabling the two annular gears to mesh with the first and second gears respectively avoids installation inconvenience due to phase difference between the first and second gears and eliminates interference during rotation of the two annular gears. By means of changing the number of teeth of each gear, the planetary gear speed reducer can provide a low, medium or high reduction ratio.

### BACKGROUND OF THE INVENTION

1. Field of the Invention The present invention relates to transmission mechanisms and more particularly, to a planetary gear speed reducer.

2. Description of the Related Art

In mechanics and related fields, such as machine tools, automatic manufacturing equipments, vehicle carriers, electrical/pneumatic tools or electrical home appliances, gear transmission devices are commonly used with a power source to provide a high torque and low speed output, enabling different products to be used and operated effectively by users.

For speed reduction ratio below 10, a single-step parallel shaft spur gear speed reducer or planetary gear speed reducer may be used. When a relatively higher speed reduction ratio is required, a multi-step speed reducer is necessary. High speed reduction ratio type gear transmission mechanisms, such as worm gear speed reducer, harmonic drive or cyclo drive, are commercially available. A single-step worm gear speed reducer has a high speed reduction ratio about 30-60, however its transmission efficiency is low (about 50-60%). A cyclo drive has better transmission efficiency (about 70%), however its cost is high and its speed reduction ratio is simply about 30-55. A harmonic drive has a high speed reduction ratio (about 100-200) and better transmission efficiency (about 60%), however its cost is higher than cyclo drive. Further, the flexible mechanism of a harmonic drive is not suitable for high power transmission. Therefore, harmonic drives are commonly used in joints of mechanical arms.

Conventional high speed reduction ratio type gear transmission mechanisms commonly have the drawbacks of complicated structure, high manufacturing cost, low transmission efficiency and low output torque. Further, following the development of high speed servo motors, speed reducers having a speed reduction ratio over 200-500 must be used in certain situations and the size of speed reducers must be controlled within a limited range. Commercial gear transmission mechanisms cannot satisfy the requirement for such a high speed reduction ratio. Designing a speed reducer to satisfy this requirement is complicated and difficult.

### SUMMARY OF THE INVENTION

The present invention has been accomplished under the circumstances in view. It is the main object of the present invention to provide a planetary gear speed reducer, which can be selectively made to provide a low, medium or high reduction ratio. It is another object of the present invention to provide a planetary gear speed reducer, which has steady, compact, light weight and small-sized characteristics. To achieve the foregoing objects of the present invention, a planetary gear speed reducer comprises a gear bracket, which comprises a center hole, and a first locating portion, a second locating portion and a third locating portions arranged in parallel along the center hole, a sun gear mounted in the center hole of the gear bracket, first gears rotatably mounted in between the first and second locating portions of the gear bracket and meshed with the sun gear, second gears rotatably mounted in between the second and third locating portions of the gear bracket and meshed with the sun gear, and two annular gears respectively meshed with the first gears and the second gears.

Based on the aforesaid technical features, the number of the first gears and the number of the second gears can be equal or different subject to actual requirements. Further, the two annular gears are respectively meshed with the first and second gears, avoiding installation inconvenience due to phase difference between the first gears and the second gears. Further, gear bracket has steady, compact, light weight and small-sized characteristics.

Other benefits, advantages and features of the present invention will be fully understood by reference to the following detailed description in conjunction with the accompanying drawings.

### BRIEF DESCRIPTION OF THE DRAWINGS

FIG. 1 is an exploded view of a planetary gear speed reducer in accordance with a first embodiment of the present invention.

FIG. 2 is a sectional view of the planetary gear speed reducer in accordance with the first embodiment of the present invention.

FIG. 3 is an exploded view of a planetary gear speed reducer in accordance with a second embodiment of the present invention.

FIG. 4 is a sectional view of the planetary gear speed reducer in accordance with the second embodiment of the present invention.

FIG. 5 is an exploded view of he planetary gear speed reducer in accordance with a third embodiment of the present invention.

### DETAILED DESCRIPTION OF THE INVENTION

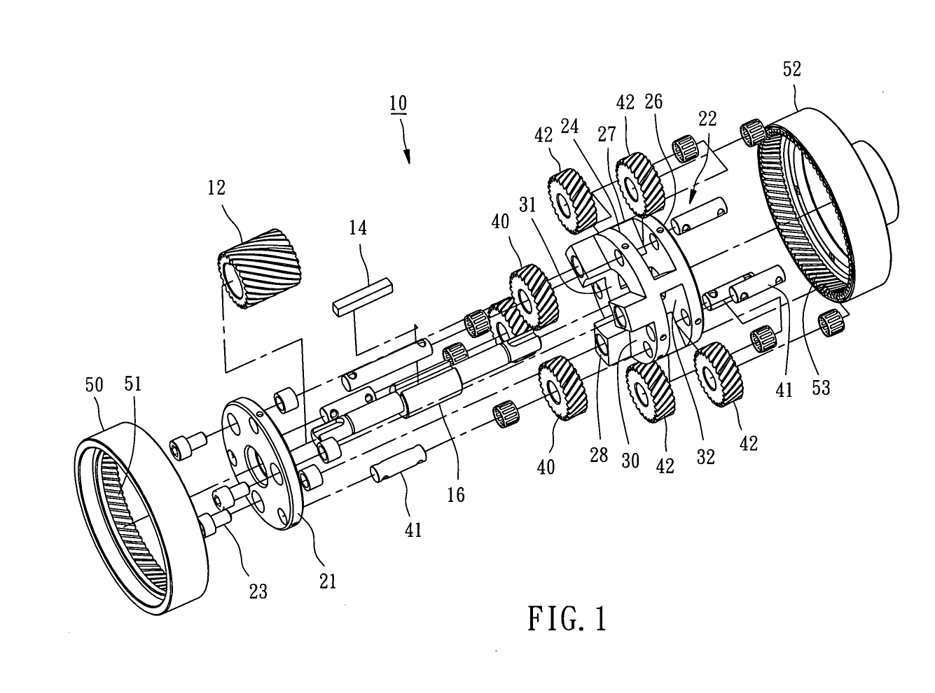

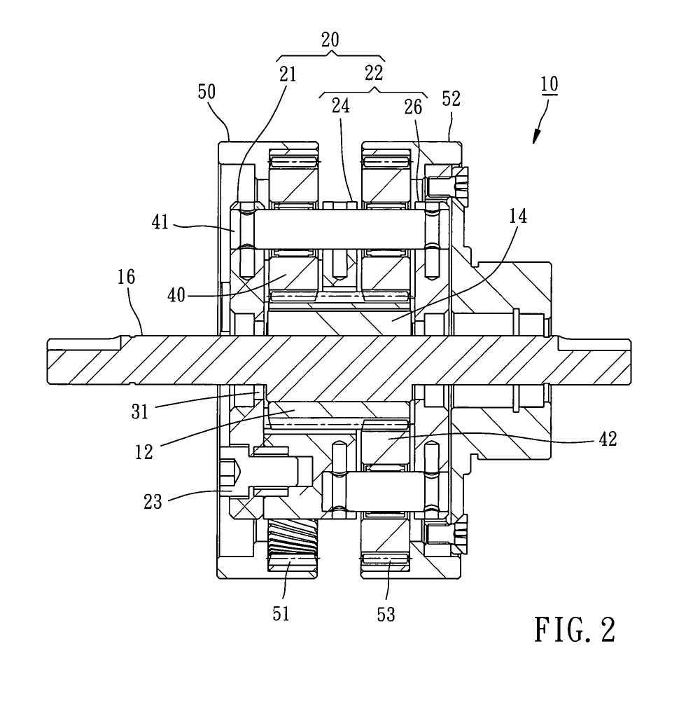

Referring to FIGS. 1 and 2, a planetary gear speed reducer 10 in accordance with a first embodiment of the present invention is shown comprising a sun gear 12, a gear bracket 20, a number of first gears 40, a number of second gears 42, a first annular gear 50 and a second annular gear 52.

The sun gear 12 is secured to a shaft 16 by a rectangular key 14 so that rotating the shaft 16 causes synchronous rotation of the sung gear 12 with the shaft 16. The gear bracket 20 comprises a base frame 22. The base frame 22 has an annular plate-shaped second locating portion 24 and an annular plate-shaped third locating portion 26 arranged in parallel, four connection portions 27 connected between the second locating portion 24 and the third locating portion 26 and equiangularly spaced from one another, four second accommodation chambers 32 defined between the second locating portion 24 and the third locating portion 26 and spaced by the connection portions 27, and three extension blocks 28 protruded from one side of the second locating portion 24 opposite to the third locating portion 26 and equiangularly spaced from one another. The gear bracket 20 further comprises an annular plate-shaped first locating portion 21, and three screw bolts 23 affixing the first locating portion 21 to the extension blocks 28 at the second locating portion 24 of the base frame 22. Thus, the first locating portion 21, the second locating portion 24 and the third locating portion 26 are kept in parallel and equally spaced from one another. Further, three first accommodation chambers 30 are defined between the first locating portion 24 and the second locating portion 24 and spaced by the extension blocks 28. The base frame 22 further has a center hole 31. The first accommodation chambers 30 and the second accommodation chambers 32 are spaced around the center hole 31. The sun gear 12 is mounted in the center hole 31. The shaft 16 extends along the axis of the center hole 31.

The first gears 40 are respectively mounted in the first accommodation chambers 30 and rotatable on a respective pivot rod 41 that is inserted through the first locating portion 21 and the second locating portion 24. Thus, the first gears 40 are rotatably mounted in the gear bracket 20 and meshed with the sun gear 12. The second gears 42 are respectively mounted in the second accommodation chambers 32 and rotatable on a respective pivot rod 41 that is inserted through the second locating portion 24 and the third locating portion 26. Further, the second gears 42 are meshed with the sun gear 12. Thus, rotating the sun gear 12 synchronously rotates the first and second gears 40 and 42 in the gear bracket 20.

The first annular gear 50 and the second annular gear 52 each have a series of teeth located 51 or 53 on the respective internal wall. Further, there is a tooth number difference between the first annular gear 50 and the second annular gear 52. This tooth number difference can be 1-4 teeth subject to the actual speed reduction requirement. The first annular gear 50 and the second annular gear 52 are sleeved onto the gear bracket 20, keeping the respective series of teeth located 51 and 53 in mesh with the first gears 40 and the second gears 42 respectively.

Based on the aforesaid structural arrangement, when rotating the shaft 16 to drive the sun gear 12 as the first annular gear 50 is kept in position and prohibited from rotation, the first gears 40 and the second gears 42 will be rotated by the sun gear 12 synchronously to move along the series of teeth located 51 of the first annular gear 50 and the series of teeth located 53 of the second annular gear 52 around the sun gear 12 respectively. Because there is a 1-4 tooth number difference between the first annular gear 50 and the second annular gear 52 and because the first annular gear 50 is kept in position and prohibited from rotation, the second annular gear 52 will be driven to rotate by the first gears 40 and the second gears 42 subject to the tooth number difference. Thus, the second annular gear 52 can be connected to a transmission mechanism (not shown), achieving low output speed and high torque.

It is to be understood that either the first annular gear 50 or the second annular gear 52 can be selectively kept in position and prohibited from rotation. When the first annular gear 50 is prohibited from rotation, a speed reduction effect of positive reduction ratio is obtained. On the contrary, when the second annular gear 52 is prohibited from rotation, a speed reduction effect of negative reduction ratio is obtained.

The speed reduction ration can be changed easily by means of changing the number of teeth of the sun gear 12, the first and second gears 40 and 42 and the first and second annular gears 50 and 52. For example, the number of the first gear 40 is the common factor of the number of teeth of the sun gear 12 or the first annular gear 50 and the total number of teeth of the sun gear 12 and the first annular gear 50; the number of the second gear 42 is the common factor of the number of teeth of the sun gear 12 or the second annular gear 52 and the total number of teeth of the sun gear 12 and the second annular gear 52. Assume the number of teeth of the sun gear 12, the number of teeth of the first annular gear 50 and the number of teeth of the second annular gear 52 are 24, 75 and 76 respectively, thus the number of the first gear 40 and the number of the second gear 42 will be 3 and 4 respectively. Further, if the number of teeth of each first gear 40 and the number of teeth of each second gear 42 are 24, the reduction ratio is calculated subject to the law of relative velocity to be 312.5. Therefore, the reduction ratio can be increased simply by changing the number of teeth of the first and second annular gears 50 and 52, the sun gear 12 and the first and second gears 40 and 42 without changing the composition components.

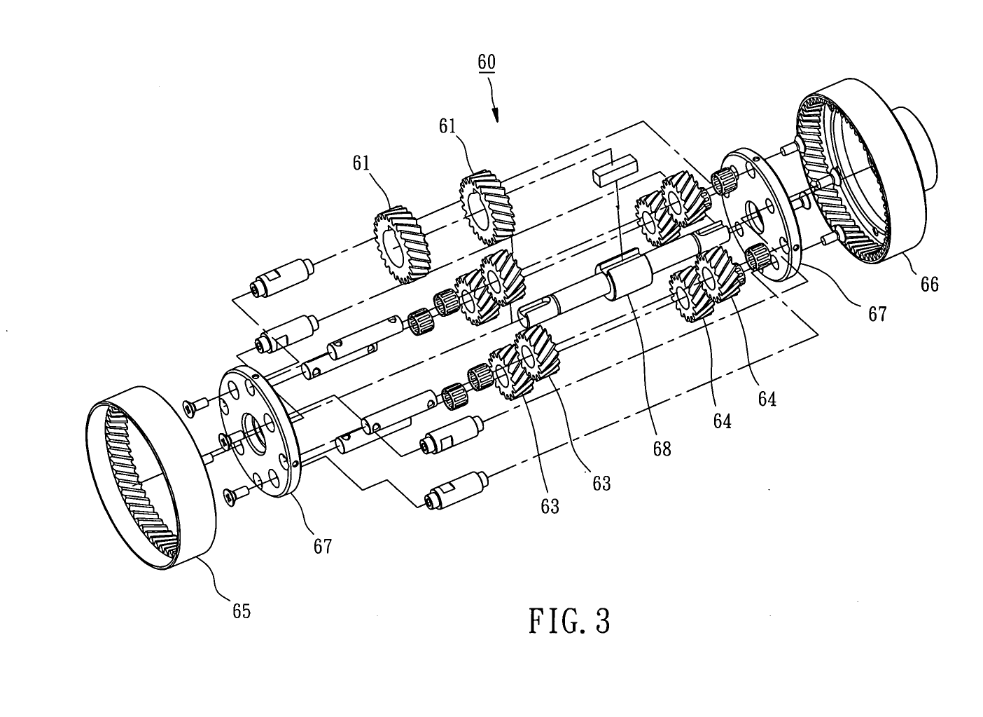

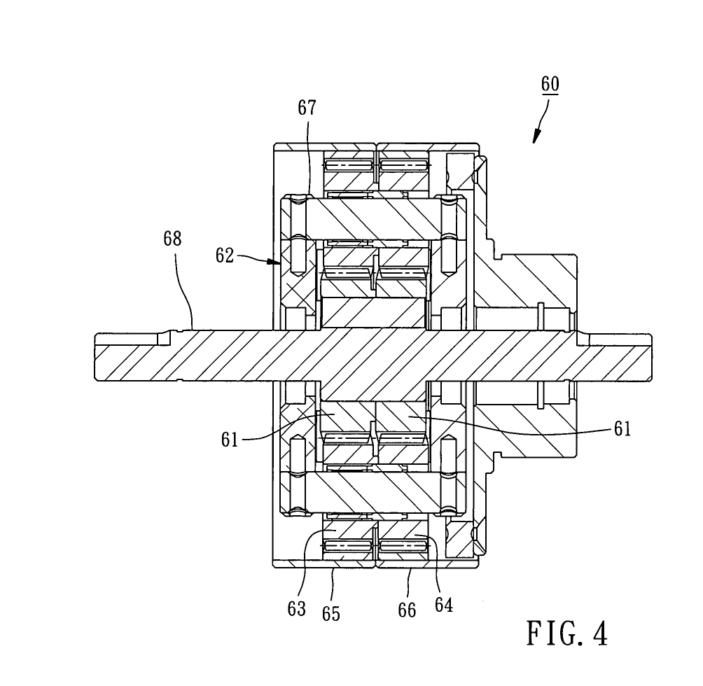

Further, the number of the first gears 40 and the number of the second gears 42 can be equal or different subject to actual requirements. Further, the first and second annular gears 50 and 52 are respectively meshed with the first and second gears 40 and 42, avoiding installation inconvenience due to phase difference between the first gears 40 and the second gears 42. Further, the gear bracket 20 utilizes the second locating portion 24 to support the first and second gears 40 and 42, allowing the first and second gears 40 and 42 to be rotated independently. The gear bracket 20 has steady, compact, light weight and small-sized characteristics. Further, the coaxial design of the sun gear 12, gear bracket 20 and first and second annular gears 50 and 52 provides a better dynamic balance. Thus, the planetary gear speed reducer is practical for high reduction ratio and high torque applications. Further, the noise level of the planetary gear speed reducer during operation is low. Except of high speed reduction ratio, the invention can be alternatively arranged to provide a low or medium speed reduction ratio. FIGS. 3 and 4 show a planetary gear speed reducer in accordance with a second embodiment of the present invention. The planetary gear speed reducer 60 according to this second embodiment comprises two sun gears 61, a gear bracket 62, a number of first gears 63, a number of second gears 64, a first annular gear 65 and a second annular gear 66. This second embodiment is characterized by that the gear bracket 62 simply has two annular plate-shaped locating portions 67; the number of the first gears 63 and the number of the second gears 64 are same; the first gears 63 and the second gears 64 are respectively coaxially arranged between the two annular plate-shaped locating portions 67 of the gear bracket 62; the two sun gears 61 are mounted on the shaft 68. During operation of the planetary gear speed reducer 60, the two sun gears 61 drive the first gears 63 and the second gears 64 to rotate the first annular gear 63 and the second annular gear 64 respectively. In one example of the present invention, the number of teeth of one sun gear 61 is 40; the number of teeth of the other sun gear 61 is 36; the number of teeth of each first gear 63 is 18; the number of teeth of each second gear 64 is 22; the number of teeth of the first annular gear 65 is 76; the number of teeth of the second annular gear 66 is 80. Thus, the speed reduction ratio of the planetary gear speed reducer 60 is 20.

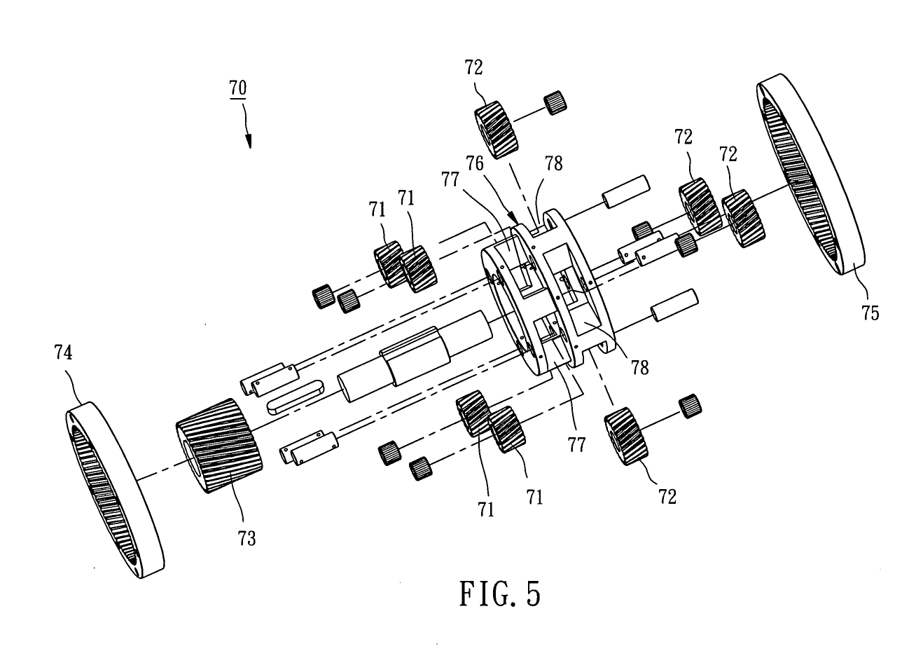

Referring to FIG. 5, a planetary gear speed reducer 70 in accordance with a third embodiment of the present invention is similar to that of the first embodiment, having the following difference. The gear bracket 76 includes four first accommodation chambers 77 arranged equiangularly and four second accommodation chambers 78 arranged equiangularly. The first and second accommodation chambers 77 and 78 do not align with each other. When the number of teeth of the sun gear 73 is 36, the number of teeth of the first gears 71 is 18, the number of teeth of the second gears 72 is 24, the number of teeth of the first annular gear 74 is 72, and the number of teeth of the second annular gear 75 is 84, each of the first and second gears 71 and 72 is four in number and they are mounted in the first and second accommodation chambers 77 and 78 separately. In the third embodiment, after calculation, it can be learned that the speed reduction ratio is 21 while the second annular gear 75 outputs rotation if the first annular gear 74 is fixed; if the second annular gear 75 is fixed, while the first annular gear 74 outputs rotation, the speed reduction ratio is −20. As can be known from the above embodiments, as long as the number of teeth of each gear is changed, the planetary gear speed reducer can provide a low, medium or high reduction ratio.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A planetary gear speed reducer, comprising:
a gear bracket, said gear bracket comprising a center hole, and a first locating portion, a second locating portion and a third locating portions arranged in parallel along said center hole;
a sun gear mounted in said center hole of said gear bracket;
a plurality of first gears rotatably mounted in between said first locating portion and said second locating portion of said gear bracket and meshed with said sun gear,
a plurality of second gears rotatably mounted in between said second locating portion and said third locating portion of said gear bracket and meshed with said sun gear,
a first annular gear meshed with said first gears; and
a second annular gear meshed with said second gears.

2. The planetary gear speed reducer as claimed in claim 1, wherein the number of said first gears is the common factor of the total number of teeth of the sun gear and the first annular gear and the number of teeth of the sun gear or the first annular gear.

3. The planetary gear speed reducer as claimed in claim 1, wherein the number of said second gears is the common factor of the total number of teeth of the sun gear and the second annular gear and the number of teeth of the sun gear or the second annular gear.

4. The planetary gear speed reducer as claimed in claim 1, wherein the difference between the number of teeth of the first annular gear and the number of teeth of the second annular gear is more than 1.

5. The planetary gear speed reducer as claimed in claim 1, wherein said first gears are respectively arranged in a coaxial manner relative to said second gears.

6. The planetary gear speed reducer as claimed in claim 1, wherein said first gears are respectively arranged in a non-coaxial manner relative to said second gears.

7. The planetary gear speed reducer as claimed in claim 1, further comprising a shaft inserted through said sun gear and adapted for rotating said sun gear.

8. A gear bracket for planetary gear speed reducer, comprising three annular locating portions coaxially arranged in parallel and two accommodation chambers respectively defined between each two adjacent ones of said three annular locating portions for accommodating a plurality of gears in each said accommodation chamber.

9. The gear bracket as claimed in claim 8, wherein the gears accommodated in said two accommodation chambers are respectively arranged in a coaxial manner.

10. The gear bracket as claimed in claim 8, wherein the gears accommodated in said two accommodation chambers are respectively arranged in a non-coaxial manner.
